(19) United States
(12) Patent Application Publication
(10) Pub. No.: US 2003/0031428 A1
(43) Pub. Date: Feb. 13, 2003

(54) Parellel electro-optic interface assembly

(76) Inventors: Randy Wickman, Cadott, WI (US); Jane Novacek, Eau Claire, WI (US); Steven C. Nelson, Fall Creek, WI (US); John Greene, Chippewa Falls, WI (US); Gary O'Connor, Bolingbrook, IL (US); Ronald Kunkle, Jim Falls, WI (US); Scott Banike, Montgomery, IL (US); David Barneson, Eleva, WI (US); Bryan Gregory, Glen Ellyn, IL (US); Daniel Mansur, Chippewa Falls, WI (US)

Correspondence Address: Jon P. Christensen, Welsh & Katz, Ltd., 22nd Floor, 120 South Riverside Plaza, Chicago, IL, 60606, US

(21) Appl. No.: 10/194,272

(22) Filed: Jul. 12, 2002

Related U.S. Application Data
(60) Provisional application No. 60/305,497, filed on Jul. 13, 2001.

(51) Int. Cl. G02B 6/43; G02B 6/42

(52) U.S. Cl. 385/89; 385/88

(57) ABSTRACT

A method and apparatus are provided for coupling an optical signal between an optical array and a flexible optical waveguide. The method includes the steps of disposing the optical array on an optically transparent substrate with an axis of transmission of an optically active element of the optical array passing directly through a body of the substrate, aligning a set of guide pins to the optically active element of the optical array, securing the aligned guide pins to the substrate and detachably coupling the flexible optical waveguide to the guide pins so that the axis of transmission of the optically active element is aligned with an axis of transmission of the flexible optical waveguide.

### FIELD OF THE INVENTION

The field of the invention relates to optical communication systems and more particularly to connectors for optical communication systems.

### BACKGROUND OF THE INVENTION

Short electronic interconnects are often needed between semiconductor photonic devices such as lasers and photodiodes and electronic interface circuitry. This electronic circuitry could include photonic signal drivers and photonic signal receivers. The short electronic interconnects are advantageous because they allow for higher transmission speeds by reducing impedance and noise pickup.

The need for decreased distance between photonic devices and electrical interface circuitry increases as the signaling data rate increases. Photonic components are often placed on simple carrier substrates to verify operation, to do burn-in, or to facilitate handling of that device.

The photonic device and carrier substrate may then be placed on another substrate and additional packaging may be completed. This packaging adds additional electrical interfaces, such as wire bonds and long non-controlled impedance wires, decreasing the electrical performance of the photonic device.

One example involves the use of an electron-optic TO can with an optical port. After placing the optical component in the TO can and making electrical wirebonds, further packaging must be done to alignment the optical component with a fiber optic cable. However, the use of the TO can limits the proximity of the placement of any optical fiber adjacent the optical component and usually requires an external structure to support the optical fiber. Further, the external support often interferes with the placement of multiple fibers adjacent the can.

The net result is that the distance between the optical device and the fiber is often great, minimizing or eliminating the possibility of multiple optical devices on the same semiconductor substrate. In addition, the overall size of the package is increased with this configuration.

Commonly used vertical cavity surface emitting laser (VCSEL) structures and photodiode structures have both electrical contacts and optical ports on the same surface of the semiconductor, creating packaging problems when trying to optimize the performance of the optical and electrical interface. These packaging problems are exacerbated when the optical components have arrays of optical devices. Described below is a novel packaging technique for placing optical components in a desirable position near a printed circuit board that avoids these problems.

### BRIEF DESCRIPTION OF THE DRAWINGS

FIG. 1 depicts a stationary optical connector shown in a context of use in accordance with an illustrated embodiment of the invention;

FIG. 2 depicts a planar view of the substrate of the connector of FIG. 1;

FIG. 3 depicts alternate chip mounting techniques for the connector of FIG. 1;

FIG. 4 depicts an array of substrates that may be used with the connector of FIG. 1;

FIG. 5 depicts an underfill that may be used with the substrate of FIG. 1;

FIG. 6 depicts fabrication details of the substrate of FIG. 1;

FIG. 7 depicts alternate methods of fabricating the substrate of FIG. 1;

FIG. 8 depicts methods of forming a hinge on the substrate of FIG. 1; and

FIG. 9 depicts details of the alignment pins of FIG. 1.

### SUMMARY

A method and apparatus are provided for coupling an optical signal between an optical array and a flexible optical waveguide. The method includes the steps of disposing the optical array on an optically transparent substrate with an axis of transmission of an optically active element of the optical array passing directly through a body of the substrate, aligning a set of guide pins to the optically active element of the optical array, securing the aligned guide pins to the substrate and detachably coupling the flexible optical waveguide to the guide pins so that the axis of transmission of the optically active element is aligned with an axis of transmission of the flexible optical waveguide.

### DETAILED DESCRIPTION OF AN ILLUSTRATED EMBODIMENT

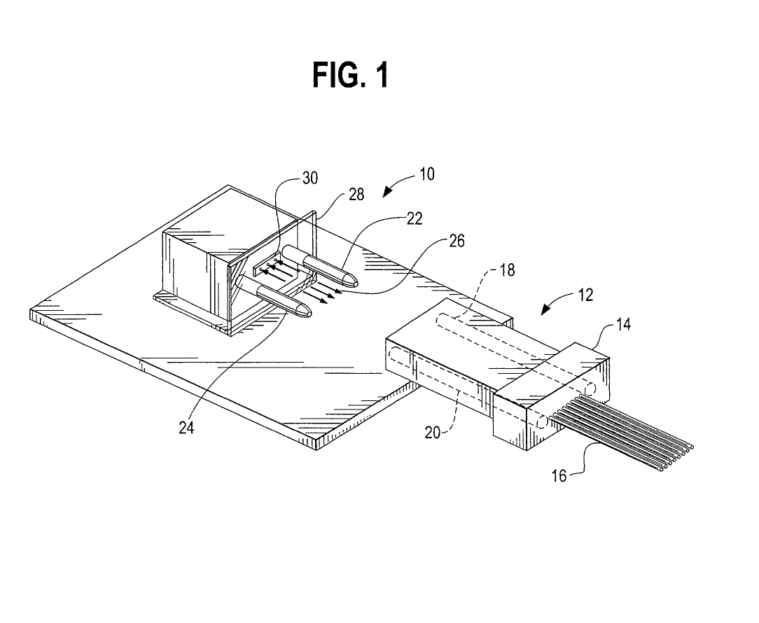

FIG. 1 is a top perspective view of a stationary optical coupler 10 in a context of use and under an illustrated embodiment of the invention. As shown, the stationary optical coupler 10 is constructed to detachably mate with a removable optical coupler assembly 12.

The detachable optical coupler assembly 12 may include an alignment plug 14 and a set of flexible optical fibers 16. The alignment plug 14 is constructed with a set of longitudinal apertures 18, 20. The optical fibers 16 extends through a front face of the plug 14 in precise alignment with the apertures 18, 20.

The stationary optical coupler 10 generally includes an optically transparent substrate 28, an optical array 30 and a set of alignment pins 22, 24. The optical array 30 is disposed on a back side of the transparent substrate 28 so that an axis of transmission 26 of an optical signal exchanged between the optical array 30 and plug 14 passes directly through a body of the substrate 28. As used herein, an axis of transmission 26 of the optical array 30 refers to transmission of an optical signal either into or from the optical array 30. Similarly, an axis of transmission 26 of the plug 14 refers to transmission of an optical signal either into or from an optical fiber of the plug 14.

The set of apertures 18, 20 allow the plug 14 to engage the set of alignment pins 22, 24 of the stationary optical coupler 10. Engagement of the pins 22, 24 into the apertures 18, 20 brings the axis of transmission 26 of the array 30 of the stationary coupler 10 into alignment with an axis of transmission of each of the optical fibers 16.

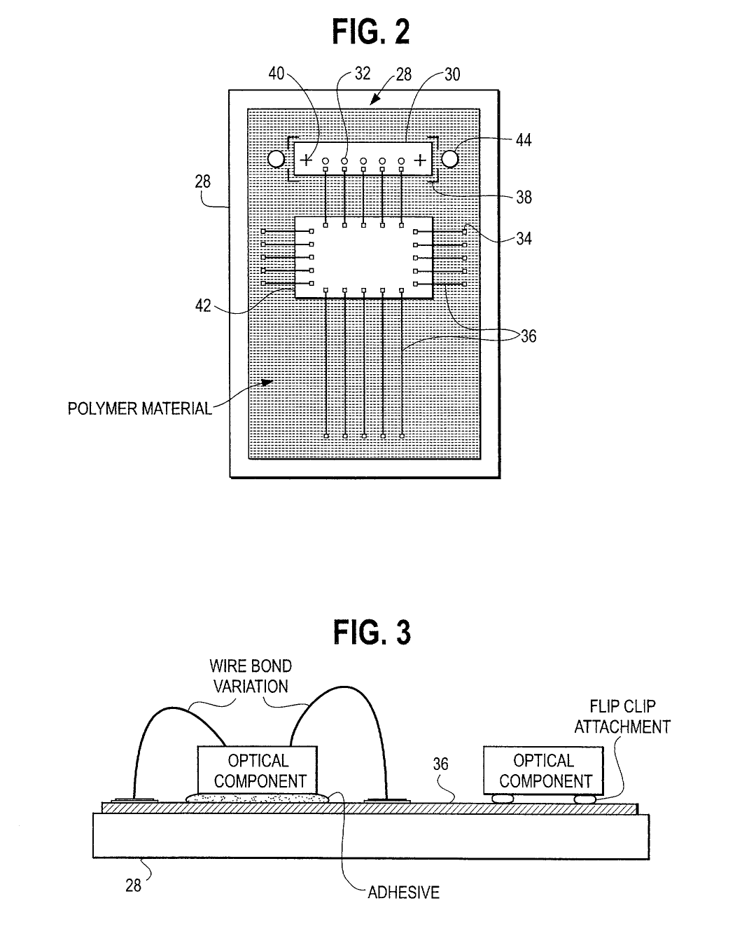

Turning now to the specifics of the stationary coupler 10, FIG. 2 shows the substrate 28, depicted under a planar format for purposes of explanation. As shown, multiple electrical traces and optical elements may be fabricated on a common optically transparent substrate 28, thereby substantially increasing the density of optical interconnects that are capable of being used in communication systems.

FIG. 2 shows an optical array 30 where a set of optical ports 32 (five shown in FIG. 2) are oriented normal to the page (i.e., the axis of transmission 26 of FIG. 1 is normal to the page). The ports 32 of the optical array 30 may be any optically active device (e.g., VSCEL lasers, PIN diodes, etc.).

Also shown on the optically transparent substrate 28 of FIG. 2 are electrical pads 34, electrical traces 36 and registration targets 38, 40. The first set of registration targets 38 may be disposed on the substrate 28 and may be used for aligning the array 30 to the substrate 28. Pick and place equipment may use the first set of registration targets 38 to position the optical array 30 relative to the targets 38 to within +/−25 microns accuracy.

The second set registration targets 40 may be disposed on the array 30 and may be used in critical micron or submicron alignment of the optical array to the external connector 12. The use of the second set of targets 40 will be explained in more detail below.

Also shown on the substrate 28 of FIG. 2 is a signal processor 42. In the case where the ports 32 are laser diodes, the signal processor may be an application specific integrated circuit (ASIC) and may include such functions as signal multiplexing and power amplification for driving the lasers with signals received from other external signal processing facilities. In the case where the ports 32 are optical detectors, the signal processor 42 may include such functions as signal detection and demultiplexing.

By placing the electrical and optical components on the same transparent substrate 28, the distance between components is minimized. The minimized spacing decreases electrical parasitics and electrical cross-talk and increases the signal integrity. For example, the substrate 28 may be used to minimize the distance between a high-speed photodiode and an electrical signal amplifier without adversely affecting the ability to couple light into the optical ports 32. The transparent substrate 28 with single or multiple electrical and optical devices may then be mounted to an electrical printed circuit board (PCB). Mounting such a substrate to an electrical printed circuit board functions to increase the optical interconnect density as compared to traditional packaging techniques.

The substrate 28 may be fabricated of a rigid, optically clear material. The substrate 28 may be made of a material such as glass, but is not limited to such material. Use of an optically clear substrate is advantageous for coupling reasons. The optically transparent substrate 28 functions to replace prior art V-groove technologies that interface between the optical array and fiber interface, and does not require polishing of any type, as the surface of the substrate 28 is clear and smooth.

The substrate 28 may be chosen to have thermal characteristics compatible with the devices 30, 42 attached to it. The coefficient of thermal expansion (CTE) of the substrate 28 substantially matches the CTE of the two opto-electronic devices 30, 42. As the package shown in FIG. 2 is sent through reflow processes, differing expansion rates could otherwise separate the devices 30, 42 from the substrate 28.

A flip chip assembly procedure may be used to attach the substrate 28 to a printed circuit board and to attach the optical array 30 and processor 42 to the substrate 42. Flip chipping has the advantage of allowing relatively close electrical connections between the two components 30, 42. As mentioned above, relatively short electrical connections improve signal integrity by reducing electrical parasitics and variations. Variations in lead length can cause increased capacitance and inductance. If “die up” rather than “die down” connections are used, the overall size of the package may increase also. FIG. 3 offers a visual comparison of the two connection methods that may be used with the stationary optical connector 10. For the purposes of this assembly process, the flip chipping process may not be limited to stud bumping alone, but could also include solder attach processes, thermosonic gold bonding or any similar procedure.

As an alternative to conventional practices, the solder bumps or stud bumps may be placed on the substrate 28 rather than on the opto-electronic device 30. This approach may be used to expedite the process of building multiple chipset modules and, in turn, reduce costs by segregating low-yield processes to lower cost assemblies.

The transparent substrate 28 may also be used to perform the function of signal redistribution or fanout from the electro-optic interface ASIC 42 to the next level of electrical interconnection. This signal fanout increases device yields and electrical performance. Flip chipping lowers the parasitic inductance of the signals to and from the electric interface IC 42. Flip chipping both the optical and electrical components 30, 42 also reduces the number of electrical discontinuities, whether based upon solder or wire-bond joints.

Many prior art ceramic or laminated package technologies do not support flip-chip landing pads and the spaces required for an electro-optic interface IC 42. For example, if perimeter electrical trace pitches for the processor 42 and array 30 of the substrate 28 are chosen to have a value of 125 μm, then the processor 42 may have signal pads on the order of 80 to 100 μm. This suggests a pad spacing of 45 to 25 μm. This spacing is difficult, if not impossible, to produce with flip chipping, because of solder bridging. As such, the transparent substrate can be used to redistribute high pad-pitch densities to lower pad-pitch densities in order to facilitate flip chipping or wirebonding.

When electrically connecting these active components (e.g., the array 30 and processor 42) in a chip-up type of package (i.e., without flip chipping), it is difficult to support electrical traces on a 125 μm pitch. Most IC packaging technologies (e.g., conventional laminate and ceramic chip type packages) do not easily support these pitch requirements. There can also be larger variation in the electrical trace quality without flip chipping when the IC packaging line pitch is pushed to its fabrication limit. Wire bond fanout from the IC pad to a more easily producible wire-bondable pitch on the IC's substrate without flip-chipping further reduces the electrical performance (e.g., increases inductance, increases cross-talk, etc.) and increases package size.

As flip-chipping increases the electrical performance, electrical fanout on the optically transparent substrate with flip chipping also makes the next level of electrical interconnection easier. Flip-chipping allows for greater physical control of the electrical traces (trace thickness and spacing) during trace fanout on the transparent substrate. Thus, electrical properties such as impedance, inductance, capacitance, resistance and cross-talk can be controlled consistently on the transparent substrate as compared to conventional wire-bonds. Electrical trace spaces and widths of 25 μm (or smaller) are typical on the transparent substrate with flip-chipping. Electrical trace spaces and widths of 75 μm are typical on the transparent chip packaging substrates with flip-chipping.

Following attachment of the optical array 30 and IC 42 to the substrate 28, an underfill may be applied to the region between the substrate and optoelectronic device 30. The underfill may be used for various purposes such as device protection, structural stability, and eye safety. The underfill may be applied before or after the device has been attached to the substrate. One method of underfill application may include a syringe injection technique. Alternatively, the underfill may be applied to the substrate before the device is place on the substrate. FIG. 5 shows the underfill under each device 30, 42.

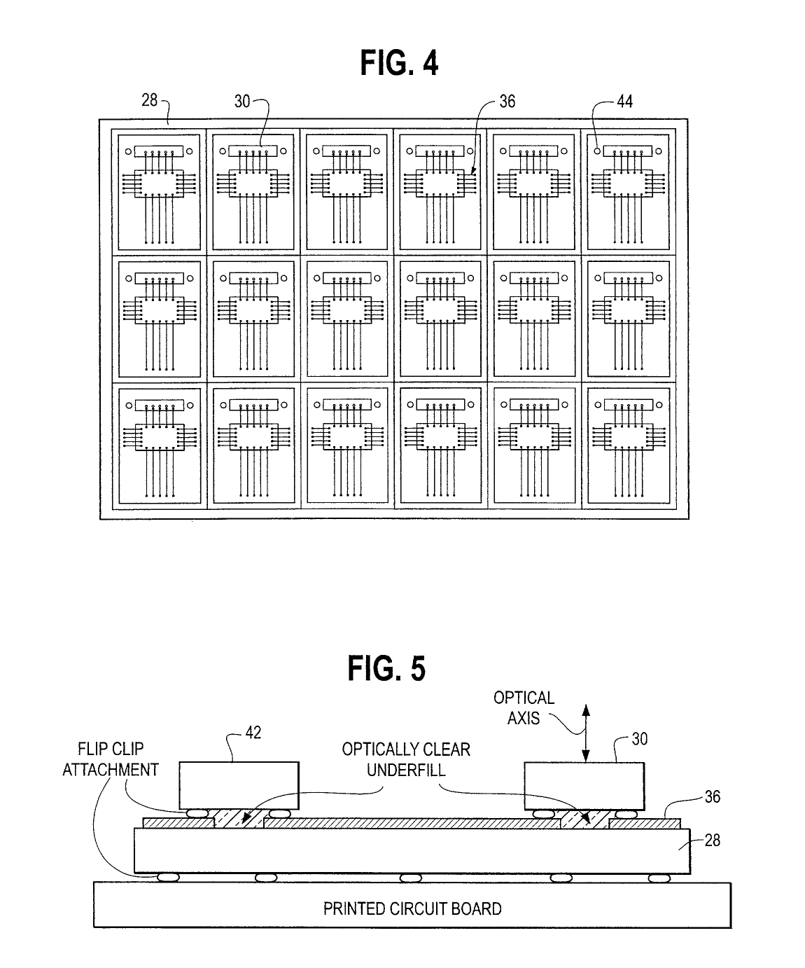

The planar nature of the transparent substrate allows traditional pick and place assembly of the optical array 30 and IC 42 to the substrate 28. Processing and assembly of the device in an array format 10 allows high volume placement of components on the substrate 28, as shown in FIG. 4. The alignment features 40 used in aligning an external connector 12 to the connector 10 is shown in FIG. 1. The preferred alignment mechanism uses guide pins 22, 24 that are inserted through apertures 44 (shown in FIG. 2) in the optically transparent substrate 28. The alignment apertures 44 in the substrate are located according to the alignment features 32 and 40 on the optical array 30 and not based upon any feature of the substrate 28. Alternatively, other features on the optical array may be used for hole placement (e.g., optical ports, electrical traces and pads, or any additional alignment feature placed on the array 30). The apertures 44 may be aligned to the alignment features 40 with a tolerance of +/−5 microns or less (e.g., ½ micron). Possible methods of cutting holes (i.e., the apertures) in the substrate include, but are not limited to: laser ablation, chemical etching, plasma etching, or any similar process. The preferred method of material removal is laser ablation, due to its high precision and tolerances.

FIG. 5 shows a side view of the package with the opto-electronic components 30, 42 placed on the planar optically transparent substrate 28. In this figure, the optical axis is orthogonal to the PCB. This arrangement would add overall size to the package which the optical fibers are connected. To have the optical axis parallel to the plane of the PCB in FIG. 5, the opto-electronic package would have to be positioned perpendicular to the PCB. This would require additional electrical cards or connectors. Standing this device on end would also add difficulty to assembly using a pick and place machine. In general, electronic board manufacurer's assembly equipment are designed to work with electronic packages that have a lower profile.

Optical signals in FIG. 5 could be turned parallel to the PCB by either physically rotating the transparent substrate 28 or through the addition of an optical structure, such as a waveguide or fiber with a tilted mirror or grating. Yet, angled optical waveguides are difficult to manufacture and are complicated to design. Light coming from an optical array contains randomly polarized light. A system of mirrors needed to redirect light will have polarization effects on the signal that decrease the signal to noise ratio.

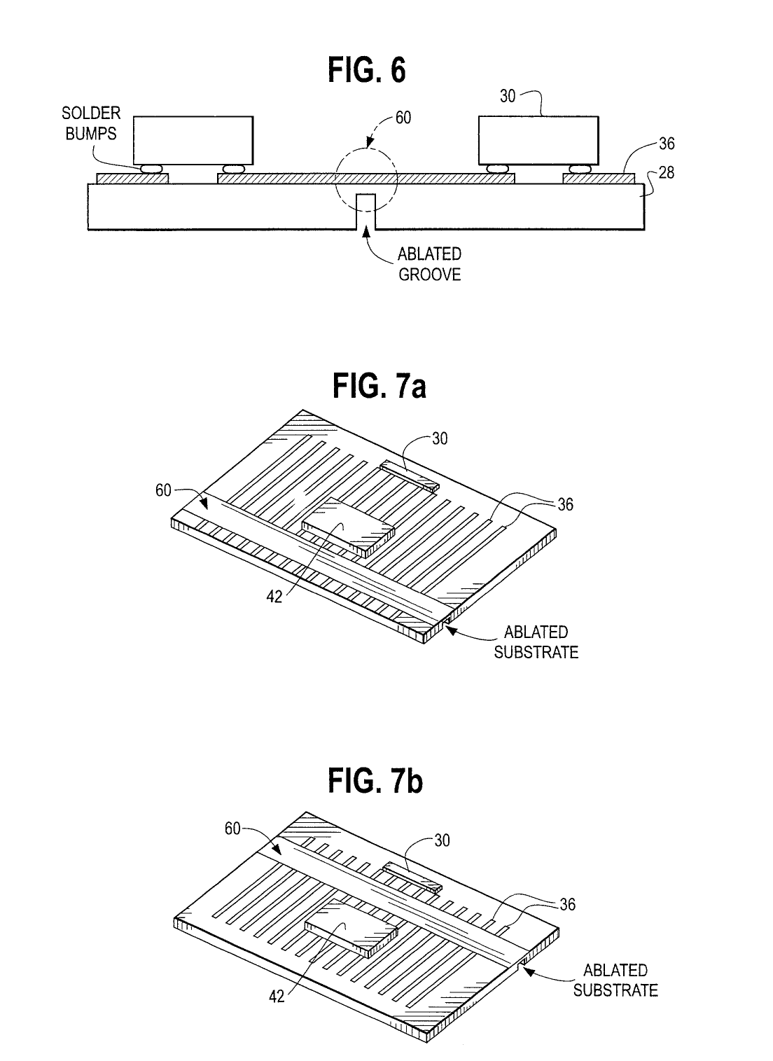

Described herein is a method of positioning the optical axis (i.e., the axis of transmission 26) parallel to the printed circuit board. The innovation contained herein stems from the assumption that it is more feasible and desirable to redirect electrons than photons. By removing a portion of the transparent substrate between the optical array 30 and the electronic IC 42, breaking the substrate at this location and bending one portion of the substrate to a ninety-degree angle, the direction of the optical axis is parallel to the printed circuit board. FIG. 6 depicts the removed substrate at the break region. The preferred method of material removal is a precision scribe line made by a laser. Breaking and rotating the substrate 28 in this region has the advantage of costing less than adding photon bending waveguide devices to the optical transceiver. It also minimizes the package profile, resulting in a planar device particularly well adapted for use with pick and place packaging equipment. In an additional embodiment of the invention, the substrate region could be bent and rotated to a desired angle, rather than breaking the substrate. In this case, the substrate 28 may be heated using a hot, electrically heated wire and rotated as described above.

The substrate 28 could also be fabricated as a pre-formed material with a notch along the width at the break point, thus eliminating the material removal procedure. A preformed material could comprise any material exhibiting the proper optical properties. Thus, material selection may be expanded to include those material for which a removal process is not necessary.

The location of the removed material (i.e., the break point) is not limited to any particular location. The removal region, and thus the break region, could be located on either side of the optical array 30 or IC 42, as shown in FIGS. 7a and 7b.

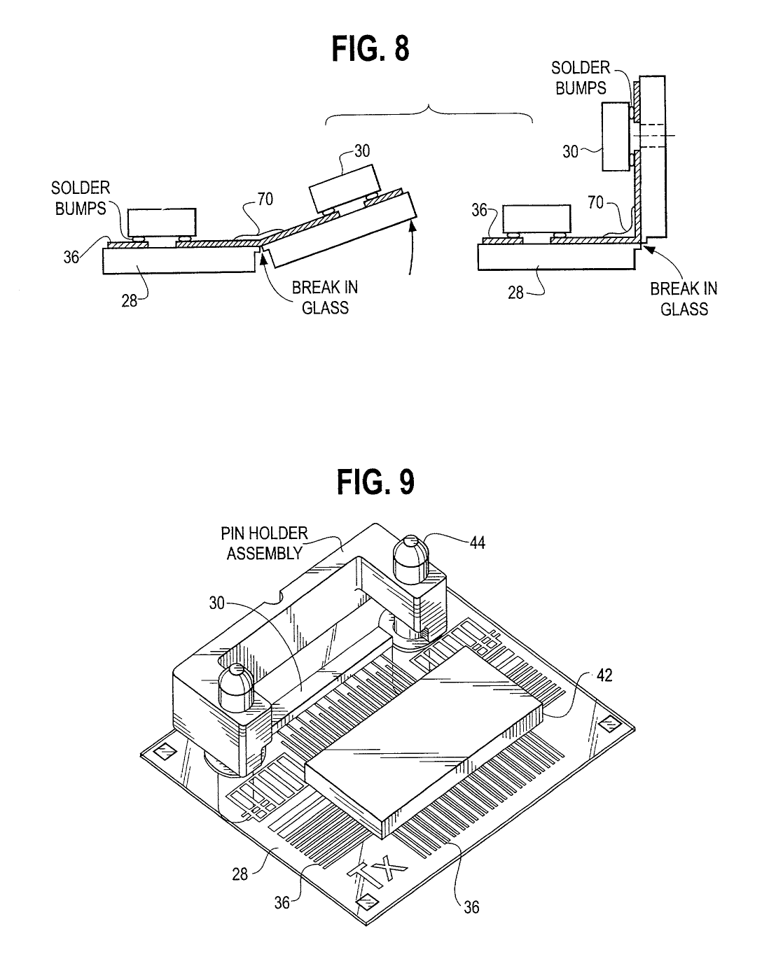

With either type of material, the remaining section of the substrate 28 would break upon rotation. The now two-member substrate 28 may be attached to additional materials that provide structural support for the two members on either side of the break. FIG. 8 shows a side view of the transparent substrate 28 with the break region, corresponding traces, and rotated substrate. When a torque is applied to the substrate about the ablated groove, the material will break. Rotation of the broken halves of the member 28 continues until arriving at the desired angle. The substrate 28 may be rotated ninety-degrees in one preferred embodiment, as explained above. Just as the break region is not limited to a particular location on the substrate 28, so the rotation angle is not limited to any particular angle of rotation.

A thin (e.g., 1 μm thick) polyimide 70, or similar material, may be deposited on the surface of the substrate 28 along the break region to provide structural support in the form of a hinge. This layer 70 is shown above the ablated groove in FIG. 8. Metal traces traverse this break region connecting the optical device 30 to the IC 42.

Additional metal traces may be disposed over the break region to provide additional support. A thicker layer 70 (e.g., 20 μm) of polyimide of a higher mechanical strength may be deposited over the metal traces, bonding to both the first layer of polyimide and the additional metal traces. This would, in turn, create a flexible interconnect region. A second layer of metal, not shown in FIG. 8, may be placed on the thicker polyimide layer to provide an electrical ground plane or for additional mechanical strength and provide flexibility at the joint. As with the optically clear substrate, the coefficient of thermal expansion of the added material may be chosen to substantially match the adjacent components. When proceeding through solder reflow, the expansion rate of the mechanical stabilizer (hinge) 70 would substantially match the substrate and traces.

The specifics of the design of the stationary optical coupler 10 is not limited to one structural support over another, Rather, a combination of materials could be used to attach the two sections of substrate 28 together. In the preferred embodiment, the traces provide support in linking the two sections of substrate 28, while still maintaining electrical integrity. Additional materials, such as a polyimide, may add to the cost of the package and may not be necessary except in extreme cases. The traces provide mechanical stability with a certain amount of flexibility during the bending process and stability as the incoming ferrule is mated to the glass piece.

By adding a polyimide (flexible material) to the planar surface, a physical layer consisting of polyimide and metal traces will remain once a portion of the transparent substrate 28 is removed. Laser ablation of the substrate 28, or a similar removal process, will leave the flex region connecting the two transparent substrate sections, as seen in FIG. 8. This flex region enables some vertical adjustment when locking the optical subassembly into position using an alignment pin holder.

The pin holder supports an external fiber connector 12, the optical array of the photonic device, and provides a thermal path for the active components 30, 42. FIG. 9 depicts the relationship between the optically transparent substrate 28 and the pin holder. The pin holder is inserted through the holes of the optically transparent substrate. Placement is performed on a planar array of substrates to maximize the volume of production.

A specific embodiment of a method and apparatus for providing a stationary optical connector according to the present invention has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention any and all modifications, variations, or equivalents that fall within the true spirit and scope of the basic underlying principles disclosed and claimed herein.

1. A method of coupling an optical signal between an optical array and a flexible optical waveguide, such method comprising the steps of:
disposing the optical array on an optically transparent substrate with an axis of transmission of an optically active element of the optical array passing directly through a body of the substrate;
aligning a set of guide pins to the optically active element of the optical array;
securing the aligned guide pins to the substrate; and
detachably coupling the flexible optical waveguide to the guide pins so that the axis of transmission of the optically active element is aligned with an axis of transmission of the flexible optical waveguide.

2. The method of coupling the optical signal as in claim 1 further comprising locating the optical array disposed on the substrate proximate a first end of the substrate and disposing a signal processor proximate a second end of the substrate.

3. The method of coupling the optical signal as in claim 2 further comprising dividing the optically transparent substrate along a dividing line into a first planar surface supporting the optical array and a second planar surface supporting the signal processor.

4. The method of coupling the optical signal as in claim 3 wherein the step of dividing further comprising disposing a set of electrical traces across the dividing line so that the set of traces electrically couple the array with the signal processor.

5. The method of coupling the optical signal as in claim 4 further comprising rotating the first planar surface relative to the second planar surface along the dividing line.

6. The method of coupling the optical signal as in claim 5 wherein the step of rotating further comprises rotating the first planar surface relative to the second planar surface along the dividing line until the relative angle substantially equals ninety degrees.

7. The method of coupling the optical signal as in claim 5 wherein the step of rotating further comprising heating the substrate along the dividing line.

8. The method of coupling the optical signal as in claim 5 wherein the step of dividing the optically transparent substrate further comprises fracturing the substrate along the dividing line.

9. The method of coupling the optical signal as in claim 8 wherein the step of rotating further comprising ablating the substrate along the dividing line.

10. The method of coupling the optical signal as in claim 8 wherein the step of fracturing further comprising joining the first and second planar surfaces with a flexible hinge.

11. The method of coupling the optical signal as in claim 10 wherein the step of joining the first and second planar surfaces with a flexible hinge further comprises disposing a layer of polyimide across the dividing line.

12. The method of coupling the optical signal as in claim 1 wherein the step of disposing the optical array on the optically transparent substrate further comprises using a flip-chip process.

13. An apparatus for coupling an optical signal between an optical array and a flexible optical waveguide, such apparatus comprising:
the optical array disposed on an optically transparent substrate with an axis of transmission of an optically active element of the optical array passing directly through a body of the substrate;
means for aligning a set of guide pins to the optically active element of the optical array;
means for securing the aligned guide pins to the substrate; and
means for detachably coupling the flexible optical waveguide to the guide pins so that the axis of transmission of the optically active element is aligned with an axis of transmission of the flexible optical waveguide.

14. The apparatus for coupling the optical signal as in claim 13 further comprising the optical array disposed on the substrate proximate a first end of the substrate and a signal processor disposed proximate a second end of the substrate.

15. The apparatus for coupling the optical signal as in claim 14 wherein the optically transparent substrate further comprises a first planar surface supporting the optical array and a second planar surface supporting the signal processor.

16. The apparatus for coupling the optical signal as in claim 15 further comprising a set of electrical traces disposed across a dividing line between the first and second planar surfaces so that the set of traces electrically couple the array with the signal processor.

17. The apparatus for coupling the optical signal as in claim 16 further comprising the first planar surface being disposed at a predetermined angle with respect to the second planar surface along the dividing line.

18. The apparatus for coupling the optical signal as in claim 17 wherein the predetermined angle between the first and second planar surfaces further comprises ninety degrees.

19. The apparatus for coupling the optical signal as in claim 18 further comprising means for flexibly joining the first and second planar surfaces.

20. The apparatus for coupling the optical signal as in claim 19 wherein the means for flexibly joining the first and second planar surfaces further comprises a layer of polyimide disposed across the dividing line.

21. The apparatus for coupling the optical signal as in claim 13 further comprising the optical array disposed on the substrate under a flip-chip arrangement.

22. An apparatus for coupling an optical signal between an optical array and a flexible optical waveguide, such apparatus comprising:
an optically transparent substrate;
the optical array disposed on the optically transparent substrate with an axis of transmission of an optically active element of the optical array passing directly through a body of the substrate;
a set of guide pins aligned with the optically active element of the optical array; and
a set of apertures adapted to secure the aligned guide pins to the substrate.

23. The apparatus for coupling the optical signal as in claim 24 further comprising the optical array disposed on the substrate proximate a first end of the substrate and a signal processor disposed proximate a second end of the substrate.

24. The apparatus for coupling the optical signal as in claim 23 wherein the optically transparent substrate further comprises a first planar surface supporting the optical array and a second planar surface supporting the signal processor.

25. The apparatus for coupling the optical signal as in claim 24 further comprising a set of electrical traces disposed across a dividing line between the first and second planar surfaces so that the set of traces electrically couple the array with the signal processor.

26. The apparatus for coupling the optical signal as in claim 25 further comprising the first planar surface being disposed at a predetermined angle with respect to the second planar surface along the dividing line.

27. The apparatus for coupling the optical signal as in claim 26 wherein the predetermined angle between the first and second planar surfaces further comprises ninety degrees.

28. The apparatus for coupling the optical signal as in claim 27 further comprising a flexible hinge joining the first and second planar surfaces.

29. The apparatus for coupling the optical signal as in claim 28 wherein the flexible hinge further comprises a layer of polyimide disposed across the dividing line.

30. The apparatus for coupling the optical signal as in claim 22 further comprising the optical array disposed on the substrate under a flip-chip arrangement.

31. The apparatus for coupling the optical signal as in claim 22 wherein the optical array further comprises a plurality of one of optical transmitters and optical receivers.
